(19) United States
(12) Patent Application Publication
(10) Pub. No.: US 2013/0227006 A1
(43) Pub. Date: Aug. 29, 2013

(54) SYSTEM AND METHOD FOR ENABLING A PARTY TO JOIN AN ESTABLISHED COMMUNICATION SESSION

(71) Applicant: Venkatesh Raju, Plano, TX (US)

(72) Inventor: Venkatesh Raju, Plano, TX (US)

(73) Assignee: Samsung Electronics Co., Ltd., Suwon-si (KR)

(21) Appl. No.: 13/403,811

(22) Filed: Feb. 23, 2012

(51) Int. Cl. G06F 15/16

(52) U.S. Cl. 709/204

(57) ABSTRACT

A method for enabling a user to discover and join an established communication session is provided. The method includes receiving at a social networking service provider an identifier for a first user based on a request to establish a communication session between the first user and a second user. A third user that is approved to join the communication session is identified. The third user is notified of the communication session.

### TECHNICAL FIELD OF THE INVENTION

The present application relates generally to communication systems and, more specifically, to a technique for enabling a party to discover and join an established communication session between other parties.

### BACKGROUND OF THE INVENTION

Despite the availability of audio and video conferencing solutions, as well as group chat capability in some instant messaging (IM) systems, the majority of real-time audio, video and text communications is two-way. While the participants in such a two-way conversation may be open to their friends or associates joining the conversation, there is currently no way for a friend or associate to discover the ongoing conversation and attempt to join it.

Generally, the only way a third person may join an existing two-way conversation is to have one of the original participants invite the third person into the call. Most systems require the original participant to initiate a “conference” feature, which turns the two-way call or session into a conference, and either user can then invite additional participants.

### SUMMARY OF THE INVENTION

A method and system for enabling a user to discover and join an established communication session are provided.

In one embodiment, a method is provided that includes receiving at a social networking service provider an identifier for a first user based on a request to establish a communication session between the first user and a second user. A third user that is approved to join the communication session is identified. The third user is notified of the communication session.

In another embodiment, a system is provided that includes a social networking service provider. The social networking service provider is configured to receive an identifier for a first user. The first user is in an established communication session with a second user. The social networking service provider is also configured to identify a third user that is approved to join the communication session. The social networking service provider is also configured to notify the third user of the communication session.

In yet another embodiment, a method is provided that includes providing an identifier corresponding to a first user equipment (UE) associated with a first user to a social networking service provider based on a request to establish a communication session between the first UE and a second UE associated with a second user. The social networking service provider is configured to identify a third user that is approved to join the communication session. The social networking service provider is also configured to notify the third user of the communication session.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that enables a party to join an established communication session in accordance with the present disclosure;

FIG. 2 illustrates user equipment that is capable of participating in an established communication session that may be joined by an additional party in accordance with the present disclosure;

FIG. 3 illustrates a communication network, which may be implemented as part of the wireless network of FIG. 1, in accordance with the present disclosure;

FIG. 4 illustrates details of the bridge of FIG. 3 in accordance with a particular embodiment of the present disclosure;

FIG. 5 is a flowchart illustrating a method for establishing a communication session that may be joined by a party after being established in accordance with the present disclosure;

FIG. 6 is a flowchart illustrating a method for notifying additional parties of a communication session that has been established and may be joined in accordance with the present disclosure; and

FIG. 7 is a flowchart illustrating a method for operating the bridge of FIG. 3 as an independent component in accordance with the present disclosure.

### DETAILED DESCRIPTION OF THE INVENTION

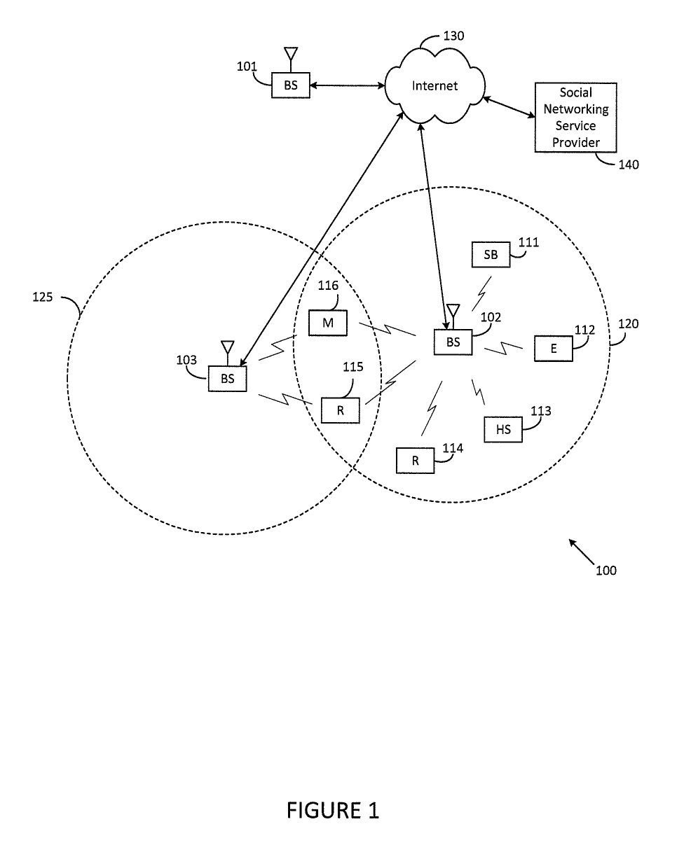

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication network.

FIG. 1 illustrates an exemplary wireless network 100 that enables a party to join an established communication session in accordance with the present disclosure. The wireless network 100 includes base station (BS) 101, base station (BS) 102, base station (BS) 103, and other similar base stations (not shown). Base station 101 is in communication with Internet 130 or a similar IP-based network (not shown).

Depending on the network type, other well-known terms may be used instead of “base station,” such as “eNodeB” or “access point.” For the sake of convenience, the term “base station” shall be used herein to refer to the network infrastructure components that provide wireless access to remote terminals.

Base station 102 provides wireless broadband access to the Internet 130 to a first plurality of subscriber stations within a coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access to the Internet 130 to a second plurality of subscriber stations in a coverage area 125 of base station 103. The second plurality of subscriber stations includes subscriber station 115 and subscriber station 116. In an exemplary embodiment, base stations 101-103 may communicate with each other and with subscriber stations 111-116 using narrowband or broadband techniques, and frequency division duplexing (FDD) or time division duplexing (TDD) techniques.

The wireless network 100 also includes a social networking service provider 140 that is configured to provide social networking services to a plurality of users. As described in more detail below, when a communication session has been established between two or more parties, such as users of two or more subscriber stations 111-116, landline telephones, personal computers and/or other suitable communication devices, additional parties may discover and join the communication session. Based on information provided by one or more of the participants in the communication session, the social networking service provider 140 may identify additional parties that are approved to join the communication session and notify those parties of the existence of the communication session. The social networking service provider 140 may also notify the approved parties of how to join the communication session.

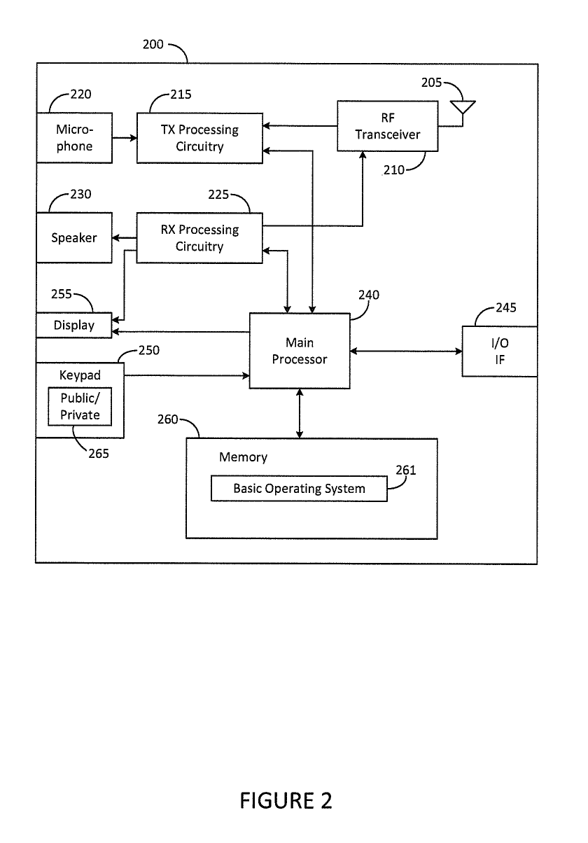

FIG. 2 illustrates user equipment 200 that is capable of participating in an established communication session that may be joined by an additional party in accordance with the present disclosure. For some embodiments, the user equipment 200 may correspond to one of the subscriber stations 111-116 of FIG. 1. For other embodiments, the user equipment 200 may correspond to a landline phone, a personal computer or other suitable communication device, whether mobile or non-mobile.

For embodiments in which the user equipment 200 is wireless, the user equipment 200 may comprise an antenna 205, a radio frequency (RF) transceiver 210, transmit (TX) processing circuitry 215, and receive (RX) processing circuitry 225. The user equipment 200 may also comprise a microphone 220, a speaker 230, a main processor 240, an input/output (I/O) interface (IF) 245, a keypad 250, a display 255, and a memory 260. The memory 260 comprises a basic operating system (OS) program 261.

The radio frequency transceiver 210 receives from the antenna 205 an incoming RF signal transmitted by a base station of the wireless network 100. The radio frequency transceiver 210 down-converts the incoming RF signal to produce a baseband signal. The baseband signal is sent to the receiver processing circuitry 225, which produces a processed baseband signal by filtering and digitizing the baseband signal and, if necessary, demodulating and/or decoding. The receiver processing circuitry 225 transmits the processed baseband signal to the speaker 230 (for voice data) or to the main processor 240 for further processing (e.g., web browsing).

The transmitter processing circuitry 215 receives analog or digital voice data from the microphone 220 or other outgoing baseband data (e.g., web data, e-mail, interactive video game data) from the main processor 240. The transmitter processing circuitry 215 encodes, modulates, multiplexes, and/or digitizes the outgoing baseband data to produce a processed baseband signal. The radio frequency transceiver 210 receives the outgoing processed baseband signal from the transmitter processing circuitry 215. The radio frequency transceiver 210 up-converts the baseband signal to an intermediate frequency signal and then to a radio frequency signal that is transmitted via the antenna 205.

In one embodiment of the present disclosure, the main processor 240 is a microprocessor or microcontroller. The memory 260 is coupled to the main processor 240. According to one embodiment of the present disclosure, part of the memory 260 may comprise a random access memory (RAM) and another part of the memory 260 may comprise a non-volatile memory, such as Flash memory, which acts as a read-only memory (ROM).

The main processor 240 executes the basic operating system program 261 stored in the memory 260 in order to control the overall operation of the user equipment 200. In one such operation, the main processor 240 controls the reception of forward channel signals and the transmission of reverse channel signals by the radio frequency transceiver 210, the receiver processing circuitry 225, and the transmitter processing circuitry 215, in accordance with well-known principles.

The main processor 240 is capable of executing other processes and programs resident in the memory 260. The main processor 240 can move data into or out of the memory 260, as required by an executing process. The main processor 240 is also coupled to the I/O interface 245. The I/O interface 245 provides the user equipment 200 with the ability to connect to other devices, such as laptop computers and handheld computers. The I/O interface 245 is the communication path between these accessories and the main controller 240. In addition, for embodiments in which the user equipment 200 is not wireless, the I/O interface 245 may provide the user equipment 200 with the ability to connect to a network, such as the Internet, over a wired connection.

The main processor 240 is also coupled to the keypad 250 and the display unit 255. The user of the user equipment 200 may use the keypad 250 to enter data into the user equipment 200. In addition to alphanumeric and other suitable keys, the keypad 250 may also provide a public/private key 265, which may be used as described in more detail below to switch between a private-mode communication session in which no additional parties are invited to join and a public-mode communication session in which selected additional parties are invited to join. The display 255 may be a liquid crystal display or other suitable display capable of rendering text and/or at least limited graphics from websites. It will be understood that the keypad 250 may be implemented through the display 255 when the display 255 comprises a touchscreen display.

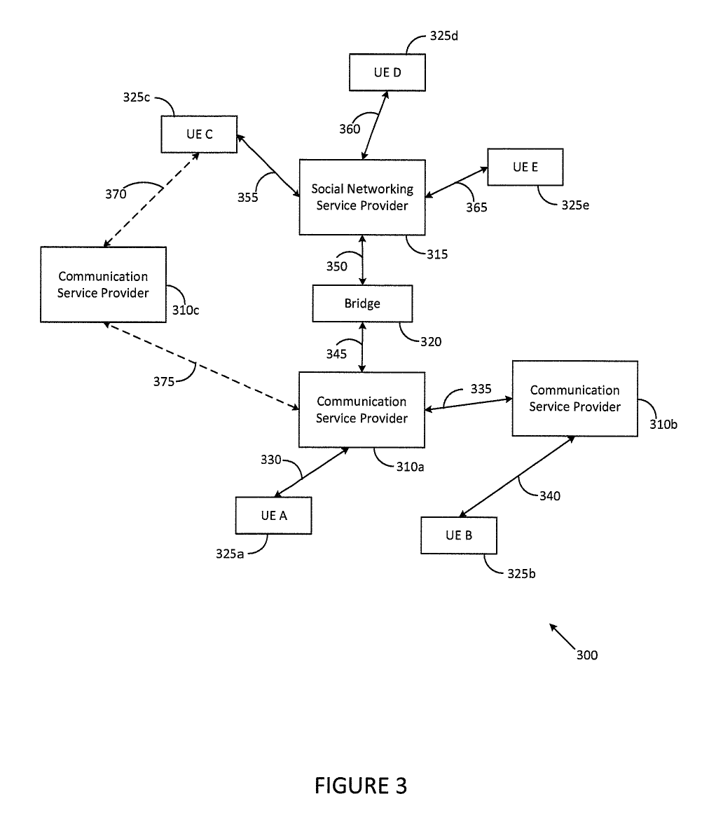

FIG. 3 illustrates a communication network 300, which may be implemented as part of the wireless network 100, in accordance with the present disclosure. The embodiment of the communication network 300 shown in FIG. 3 is for illustration only. Other embodiments of the communication network 300 could be used without departing from the scope of this disclosure.

The communication network 300 comprises one or more communication service providers 310a-c, at least one social networking service provider 315, and a bridge 320. Each communication service provider 310 is configured to provide communication services to a plurality of user equipment (UE) devices, such as UEs A, B, C, D and/or E 325a-e. Each communication service provider 310 may comprise a landline telephone company, a wireless service provider, an Internet service provider and/or any other suitable type of provider of communication services. As described below, although they are illustrated separately, any two or all three of the communication service providers 310a-c illustrated may be a same communication service provider.

Each communication service provider 310 may be configured to provide audio, video, text and/or any other suitable types of services allowing users of UEs 325 to communicate with each other. Each communication service provider 310 is configured to provide both two-party and multi-party communication services. Each of the UEs 325 may be configured to communicate with a corresponding communication service provider 310 using Session Initiation Protocol (SIP), HyperText Transport Protocol (HTTP), Global System for Mobile Communications (GSM), Code Division Multiple Access (CDMA), Public Switched Telephone Network (PSTN) and/or any other suitable protocol.

For some embodiments, the social networking service provider 315 may correspond to the social networking service provider 140. The social networking service provider 315 is configured to provide social networking services to a plurality of users, such as users of the UEs A, B, C, D and/or E 325a-e. For example, the social networking service provider 315 may be configured to provide users with the ability to discover friends and/or associates and establish online relationships. Some examples of social networking service providers are FACEBOOK, GOOGLE+, ORKUT and MYSPACE. The social networking service provider 315 may provide a social feed for each user that includes activities and messages relating to the friends and/or associates of that user.

It will be understood that each of the communication service providers 310 may provide communication services to a set of UEs 325 that is different from those UEs 325 that are used by users for whom the social networking service provider 315 provides social networking services. However, at least one UE 325 that is provided services by the communication service provider 310a has a corresponding user that is provided services by the social networking service provider 315.

The bridge 320 is configured to provide communication between at least one communication service provider 310 and the social networking service provider 315. For the illustrated embodiment, the bridge 320 is configured to provide communication between the communication service provider 310a and the social networking service provider 315. However, it will be understood that the bridge 320 may provide communication between more than one communication service provider 310 and the social networking provider 315 and/or between the communication service provider 310a and more than one social networking service provider 315. In addition, the communication network 300 may comprise a plurality of bridges 320, with each bridge 320 providing communication between one or more communication service providers 310 and one or more social networking service providers 315.

For some embodiments, the bridge 320 may comprise an independent component of the communication network 300. For other embodiments, at least a portion of the bridge 320 may be provided by the communication service provider 310 and/or the social networking service provider 315. For still other embodiments, the entire functionality of the bridge 320 may be provided by the communication service provider 310 and/or the social networking service provider 315.

As described in more detail below, the bridge 320 is configured to receive an identifier for a UE 325 or a user of a UE 325 indicating that a communication session has been established between two UEs 325. The communication session may comprise any suitable type of session involving communication between multiple parties, such as a telephone call or other audio-type communication, a video conference, an online video chat or other video-type communication, or an instant-messaging conversation or other text-type communication. The bridge 320 is also configured to notify the social networking service provider 315 of the established communication session.

The social networking service provider 315 is configured to identify additional parties who are approved to join the communication session and to notify those approved parties of the existence of the communication session. The social networking service provider 315 may also be configured to provide the approved parties with instructions for joining the communication session.

The UEs 325, such as UE A 325a, for example, each represent any suitable component that may be used by a corresponding user to communicate with either a communication service provider 310 or the social networking service provider 315. For a particular example, UE A 325a may represent a landline telephone, UE B 325b may represent a cell phone, and UEs C, D and E may represent a personal computer, a personal digital assistant, and a cell phone, respectively. In addition, references to User A, for example, refer to the user of the component UE A 325a.

In operation according to a particular example, UE A 325a initiates the establishment of a communication session with UE B 325b by communicating an initiation request over a link 330 to the communication service provider 310a, which provides communication services for UE A 325a. For example, User A may dial a telephone number for UE B 325b using a cell phone of User A, which is serviced by the communication service provider 310a. As used herein, a “link” refers to communication between two components, not necessarily an actual, physical link.

The communication service provider 310a then attempts to establish the requested session. For example, when UE B 325b is provided service by a different communication service provider 310b, the communication service provider 310a may send the initiation request over a link 335 to that other communication service provider 310b. It will be understood that this is unnecessary when UE B 325b is serviced by the same communication service provider 310a as UE A 325a.

The communication service provider 310b that services UE B 325b sends the request to UE B 325b over a link 340. For example, the communication service provider 310b may send a signal causing a cell phone of User B to ring. UE B 325b then responds to the request and the communication session is established between UE A 325a and UE B 325b. For example, User B may answer the phone.

Once the communication session is established, the communication service provider 310a provides an identifier for UE A 325a and/or UE B 325b to the bridge 320. The bridge 320 determines an identifier for User A and/or User B based on the identifier(s) from the communication service provider 310a. The bridge 320 then provides the identifier for User A and/or User B to the social networking service provider 315.

For some embodiments, the bridge 320 provides a common identifier from the communication service provider 310a to the social networking service provider 315. A common identifier is a single identifier that is known to both the communication service provider 310a and the social networking service provider 315.

For example, a social network identifier may be a common identifier. For this embodiment, the bridge 320 may be implemented as part of the communication service provider 310a. The communication service provider 310a may be configured to store the social network identifier used by User A and associate that identifier with UE A 325a. Thus, the communication service provider 310a may identify the social network identifier based on the association and provide that social network identifier to the social networking service provider 315. The social network identifier is used by the social networking service provider 315 to identify User A.

Alternatively, a communication service identifier may be a common identifier. For this embodiment, the bridge 320 may be implemented as part of the social networking service provider 315. The social networking service provider 315 may be configured to store a communication service identifier used by User A, such as a telephone number or uniform resource identifier, and associate that identifier with User A. Thus, the communication service provider 310a may provide the communication service identifier to the social networking service provider 315. The social networking service provider 315 may then identify the social network identifier based on the association with the communication service identifier. The social network identifier may then be used by the social networking service provider 315 to identify User A.

In yet another embodiment, a notification identifier may be a common identifier. For this embodiment, the bridge 320 may be implemented as part of both the communication service provider 310a and the social networking service provider 315. The notification identifier is an identifier other than the communication service identifier or the social network identifier that is known to both the communication service provider 310a and the social networking service provider 315. The notification identifier may be an email address or any other suitable existing identifier or may be an identifier that is generated specifically for the disclosed notification system.

The communication service provider 310a and the social networking service provider 315 may each be configured to store a notification identifier and associate that identifier with UE A 325a and User A, respectively. For this embodiment, the communication service provider 310a determine the notification identifier based on the communication service identifier and provide the notification identifier to the social networking service provider 315. The social networking service provider 315 may then determine the social network identifier based on the notification identifier and use the social network identifier to identify User A.

For other embodiments, no common identifier is used. For these embodiments, the bridge 320 may be implemented independently of the communication service provider 310a and the social networking service provider 315. The bridge 320 may be configured to store both a communication service identifier for UE A 325a and an associated social network identifier for User A. The communication service provider 310a provides the communication service identifier to the bridge 320. The bridge 320 then determines the social network identifier based on the communication service identifier and provides the social network identifier to the social networking service provider 315.

As described in more detail below, after identifying User A and/or User B, the social networking service provider 315 then identifies any additional parties that are approved to join the session based on information previously provided by User A and/or User B. Thus, the social networking service provider 315 may send a notification to UE C 325c over a link 355, a notification to UE D 325d over a link 360, and a notification to UE E 325e over a link 365. For this illustrated example, UEs C, D and E are the only approved additional parties. However, it will be understood that any suitable number of UEs 325 may be notified about the established communication session, including no UEs 325 or as many UEs 325 as desired by User A and/or User B.

In addition, the notification provided by the social networking service provider 315 may be provided to multiple UEs for a same approved user. For example, User C may receive notification of the established communication session on his cell phone and his laptop.

For some embodiments, the notification is provided automatically, such as by a text message or other suitable automatic notification. For other embodiments, the notification may be made available when the approved user logs into the social networking service provider 315, such as by a posting on a social networking page for the user. For still other embodiments, a combination of the automatic notification and the available notification may be provided.

If after seeing the notification of the session, User C wants to join the session, User C may attempt to join the session in accordance with any suitable method. For example, User C may communicate with the social networking service provider 315 and request to join the session. The social networking service provider 315 may then request explicit approval from User A and/or User B allowing User C to join. If User A and User B do not deny approval, the social networking service provider 315 may communicate to the communication service provider 310a that User C is to be included in the session. The communication service provider 310a may then include User C in the session in any suitable manner.

For another example, UE C 325c may communicate with a communication service provider 310c providing services for UE C 325c over the link 370. The communication service provider 310c, if different from the communication service provider 310a, may then send a request for UE C 325c to the communication service provider 310a over a link 375. The communication service provider 310a may then include UE C 325c in the communication session with UE A 325a and UE B 325b in any suitable manner. For example, for some embodiments, the communication service provider 310a may include UE 325c in the session using conventional conference calling techniques.

As described above, the social networking service provider 315 is configured to identify approved users for notification of the existence of a public-mode communication session. In accordance with some embodiments of the present disclosure, as described in more detail below, the social networking service provider 315 may store mode rules for each of a plurality of users regarding which mode should be used for various communication sessions based on any suitable criteria. The social networking service provider 315 may also store approval rules for each of a plurality of users regarding which other users to approve based on any suitable criteria. The social networking service provider 315 may also store notification rules allowing users to specify a manner in which to receive notifications and/or to limit notifications of communication sessions that they have been approved to join based on any suitable criteria, such as which users are currently participating in the communication session.

For example, User A may configure the social networking service provider 315 with a rule regarding a default mode for his communication sessions. That is, the social networking service provider 315 may store a rule designating communication sessions for User A as private-mode communication sessions. User A may then choose to override this default setting on a per-session, per-user and/or other suitable basis. For example, User A may select the public/private key 265 in order to establish a communication session having a mode different from the default mode. Thus, for this example, User A may select the public/private key 265 to change a mode for a particular communication session from the default of private mode to public mode. User A may change the mode either when the communication session is established or during the communication session.

Also, the social networking service provider 315 may store a rule designating a particular type of communication session as private-mode for a default mode, while another type of communication session is designated as public-mode for the default mode. For example, User A may select a default of private-mode for audio communication sessions and a default of public-mode for video communication sessions and text communication sessions.

As another alternative, the social networking service provider 315 may store a rule designating User A's communication sessions as public or private for a default mode based on the other original participant in the communication session, such as User B in the example of FIG. 3. For example, User A may select a default mode of private for communication sessions with Users B and D and a default mode of public for communication sessions with Users C and E. Also, these alternatives may be implemented together. For example, User A may select a default mode of public or private based on the other original participant and based on the communication session type. User A may also select an overall default mode of public or private, along with particular modifications of the default mode for selected other users and/or communication session types.

For those communication sessions that are designated as public-mode sessions, the social networking service provider 315 may also be configured to store approval rules for each user to be used in identifying approved users. For example, User A may provide a rule for each additional user, such as User C is approved for all public-mode sessions and Users D and E are not approved for all public-mode sessions. User A may also provide rules based on the identity of the other original participant, such as User B in the illustrated example. For example, User A may provide a rule that for public-mode sessions with User B, Users C and D are approved and User E is not approved, another rule that for public-mode sessions with User C, Users B and E are approved and User D is not approved, another rule that for public-mode sessions with User D, User E is approved and Users B and C are not approved, etc.

As another alternative, User A may provide rules for groups of users. For example, a first group may include Users B, C and D, while a second group includes Users E and F (not shown in FIG. 3). User A may then provide a rule that for public-mode sessions with any user in the first group, every other user in the first group is approved and users in other groups, including the second group, are not approved. Alternatively, User A may provide a rule that for public-mode sessions with any user in the first group, every other user in the first group, as well as users in the second group, is approved, while users in other groups, such as a third group, are not approved. Also, each user may be included in more than one group, if desired. It will be understood that any suitable combination of these types of rules may be provided by User A and stored by the social networking service provider 315.

For communication sessions in which both original participants have rules stored on the social networking service provider 315, the social networking service provider 315 may be configured to designate communication sessions as public or private and to identify approved users based on the more restrictive rules and/or the less restrictive rules. For example, if User A has designated a communication session as private and User B has designated the communication session as public, the social networking service provider 315 may follow the more restrictive rule and designate the session as private.

Also, if User A has indicated that Users C, D and E are approved, while User B has indicated that User D is approved, the social networking service provider 315 may be configured to either approve Users C, D and E or only User D. This may be based on a set configuration of the social networking service provider 315 or, alternatively, the users may provide rules for the social networking service provider 315 for making this determination.

For example, if User A has provided a rule indicating that the more restrictive set of approved users should be used, the social networking service provider 315 may approve only User D regardless of User B's rule. Similarly, if User B has provided a rule indicating that the more restrictive set of approved users should be used, the social networking service provider 315 may approve only User D regardless of User A's rule. On the other hand, if both User A and User B have provided rules indicating that the less restrictive set of approved users should be used, the social networking service provider 315 may approve Users C, D and E.

For embodiments in which the social networking service provider 315 stores notification rules, the social networking service provider 315 may determine a manner of notification based on each approved user's corresponding rules. For example, the social networking service provider 315 may send a text message, email and/or other suitable notification to the approved users. The social networking service provider 315 may also post a notification on a social networking page of each approved user. In addition, the social networking service provider 315 may include the notification in a status of User A and User B. The notification in the status may be visible only to approved users or the status may be visible to anyone able to access the status, with the notification showing that the session is public or private based on the viewing user's approval status. That is, unapproved users may see the session labeled as private, while approved users may see the session labeled as public.

As another example, User C may provide a rule that he would like a text message sent to a particular phone number as a notification. User D may provide a rule that she would like an email sent to a particular email address as a notification. User E may provide a rule that he would like both a text message and a posting on his social networking page as notifications.

In addition, a user may provide a rule requesting no notifications for communication sessions involving one or more users, users in one or more groups or based on any other suitable criteria. For example, User E may provide a rule requesting different types of notifications based on the users participating in the communication session or other suitable criteria. For example, User E may request a text message notification for communication sessions including User A, User C or users in a particular group and a posting on his social networking page for communication sessions including User B, User D or another particular group.

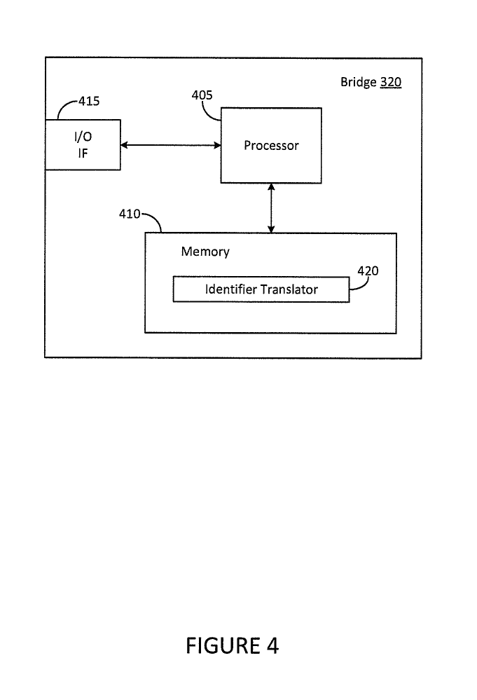

FIG. 4 illustrates details of the bridge 320 of FIG. 3 in accordance with a particular embodiment of the present disclosure in which the bridge 320 is implemented independently of the communication service provider 310a and the social networking service provider 315. The embodiment of the bridge 320 shown in FIG. 4 is for illustration only. Other embodiments of the bridge 320 could be used without departing from the scope of this disclosure.

For the illustrated embodiment, the bridge 320 comprises a processor 405, a memory 410, and an input/output (I/O) interface 415. The memory 410 is configured to store an identifier translator 420.

In one embodiment of the present disclosure, the processor 405 comprises a microprocessor or microcontroller. The memory 410 is coupled to the processor 405. The memory 410 may comprise a random access memory (RAM), a read-only memory (ROM) and/or any suitable type of data store.

The processor 405 is configured to execute a basic operating system program that may be stored in the memory 410 in order to control the overall operation of the bridge 320. The processor 405 is also configured to move data into or out of the memory 410. The processor 405 is also coupled to the I/O interface 415. The I/O interface 415 is configured to provide the bridge 320 with the ability to connect to the communication service provider 310a and the social networking service provider 315.

The identifier translator 420 comprises information providing a relationship between a communication service identifier and a social network identifier. For example, for some embodiments, the identifier translator 420 may comprise a table such as the following:

| Communication Service | |
|---|---|
| Identifier | Social Network Identifier |
| 555-342-0989 | UserA@webid.com |
| 555-668-5679 | UserB@altwebid.com |
| 555-438-2286 | UserC@webid.com |
| 555-872-5763 | UserD@webid.com |
| 555-358-4471 | UserE@altwebid.com |

Thus, for the table in this example, the processor 405 may receive a communication service identifier of 555-342-0989 from the communication service provider 310a via the I/O interface 415. For this example, the communication service identifier is the phone number of User A that is known to the communication service provider 310a and which communication service provider 310a uses to provide communication services to the UE A 325a.

The processor 405 of the bridge 320 then accesses the identifier translator 420 and identifies the social network identifier that corresponds to the received communication service identifier as UserA@webid.com. The processor 405 then provides the identified social network identifier to the social networking service provider 315 via the I/O interface 415. The social network identifier is known to the social networking service provider 315 and is used by the social networking service provider 315 to provide social networking services to User A.

Thus, for this particular embodiment, a notification may be provided from the communication service provider 310a to the social networking service provider 315 without either of these components 310a or 315 having to know any additional identifiers. For alternative embodiments, as described above, a common identifier may be known by both the communication service provider 310a and the social networking service provider 315. For some of these embodiments, at least a portion of the bridge 320 may be implemented as part of the communication service provider 310a and/or the social networking service provider 315.

For example, for these embodiments, the social networking service provider 315 may be configured to store communication service identifiers for the users for which the social networking service provider 315 provides service. For another example, the communication service provider 310a may be configured to store social network identifiers for the UEs 325 for which the communication service provider 310a provides service. For still another example, a notification identifier other than the communication service identifier and the social network identifier may be generated or used. For this example, each of the communication service provider 310a and the social networking service provider 315 is configured to store the notification identifier and to recognize the UE 325 or the user corresponding to the notification identifier.

For embodiments in which the bridge functionality is implemented as part of the communication service provider 310a and/or the social networking service provider 315, the identifier translator 420 may be stored in the component providing the bridge functionality. For example, for these embodiments, the identifier translator 420 may comprise a table such as the one described above. For another example in which a notification identifier is used, the identifier translator 420 in the communication service provider 310a may comprise a table such as the following:

| Communication Service | |
|---|---|
| Identifier | Notification Identifier |
| 555-342-0989 | UserA1234 |
| 555-668-5679 | UserB5678 |
| 555-438-2286 | UserC2468 |
| 555-872-5763 | UserD1357 |
| 555-358-4471 | UserE9876 |

For this example, a corresponding identifier translator 420 may be stored in the social networking service provider 315 as follows:

| Notification Identifier | Social Network Identifier |
|---|---|
| UserA1234 | UserA@webid.com |
| UserB5678 | UserB@altwebid.com |
| UserC2468 | UserC@webid.com |
| UserD1357 | UserD@webid.com |
| UserE9876 | UserE@altwebid.com |

Thus, for this example, the communication service provider 310a may identify the notification identifier for UE 325a, which has an associated phone number of 555-342-0989, as UserA1234 and provide that notification identifier to the social networking service provider 315. Based on that notification identifier, the social networking service provider 315 is then able to identify UserA@webid.com as the user participating in the communication session.

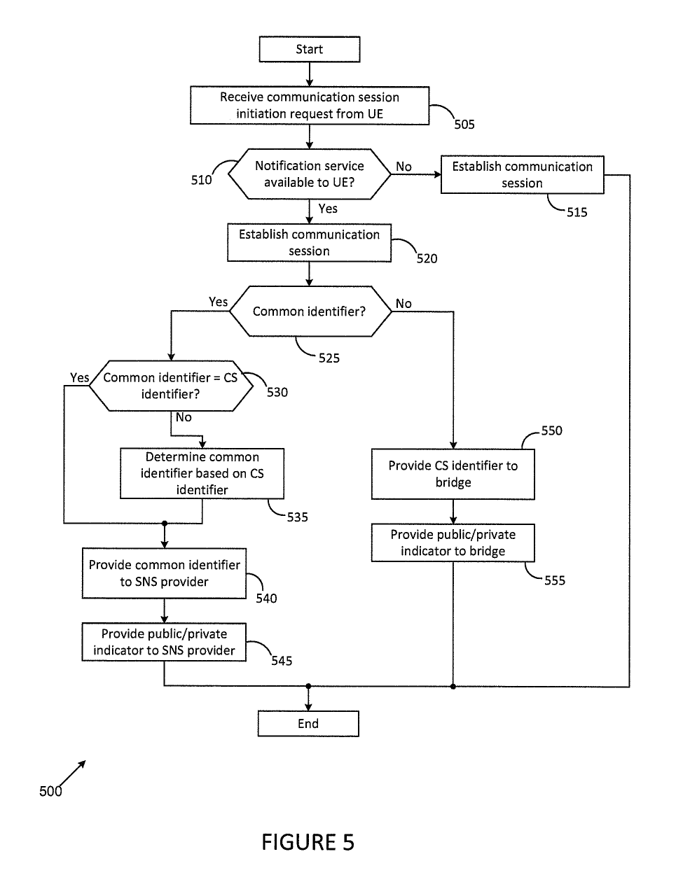

FIG. 5 is a flowchart illustrating a method 500 for establishing a communication session that may be joined by a party after being established in accordance with the present disclosure. The method 500 shown in FIG. 5 is for illustration only. The communication session may be established in any other suitable manner without departing from the scope of this disclosure.

Initially, the communication service provider 310a receives a communication session initiation request from an initiating UE 325, such as UE A 325a (step 505). The communication service provider 310a then determines whether or not a notification service is available to that UE 325 (step 510). For example, the communication service provider 310a may search stored data to determine whether or not account information for UE A 325a indicates that UE A 325a has paid to activate the notification service.

If the initiating UE 325 does not have the notification service available (step 510), the communication service provider 310a establishes the communication session in a conventional manner (step 515), and the method 500 comes to an end. However, if the initiating UE 325 does have the notification service available (step 510), the communication service provider 310a establishes the communication session (520) and also begins a process to notify the social networking service provider 315 of the communication session.

Although the following description includes decision steps (525 and 530), it will be understood that these steps simply illustrate multiple embodiments. Thus, a communication service provider 310a may be configured to operate according to a particular one of these embodiments in accordance with the decision step results. In addition, for some embodiments in which the communication service provider 310a is configured to communicate with multiple social networking service providers 315, a single communication service provider 310a may be configured to operate using more than one of the embodiments provided through the different decision steps.

For embodiments in which a common identifier is used (step 525) and the common identifier is not the communication service (CS) identifier (step 530), the communication service provider 310a determines a common identifier for the UE 325 based on the communication service identifier (step 535). For example, the communication service provider 310a may access an identifier translator 420 to determine a notification identifier corresponding to the communication service identifier. The communication service provider 310a then provides the common identifier to the social networking service provider 315 (step 540).

For embodiments in which a common identifier is used (step 525) and the common identifier is the communication service identifier (step 530), the communication service provider 310a simply provides that common identifier to the social networking service (SNS) provider 315 (step 540).

In addition to providing the common identifier to the social networking service provider 315 (step 540), the communication service provider 310a may also provide a public/private indicator to the social networking service provider 315 (step 545). For example, for embodiments in which the UE 325 comprises a public/private key 265, the communication service provider 310a may provide the public/private indicator to notify the social networking service provider 315 of the mode selected for use for the communication session regardless of any mode rules stored in the social networking service provider 315 based on user input through the public/private key 265.

Also, for other embodiments in which a user of the UE 325 may indicate a mode preference in any other suitable manner, the communication service provider 310a may provide that preference to the social networking service provider 315 in the form of a public/private indicator. For some embodiments in which the user is not provided an option of overriding the stored mode rules, step 545 may be omitted. Furthermore, the communication service provider 310a may be configured to terminate the notification portion of the method 500 at any time if a user of the UE 325 provides input indicating that the communication session should be a private-mode communication session.

For embodiments in which a common identifier is not used (step 525), the identifier is the communication service identifier. For these embodiments, an independent bridge 320 may be implemented. Thus, the communication service provider 310a provides the communication service identifier to the bridge 320 (step 550). As described above, the communication service provider 310a may also optionally provide a public/private indicator to the bridge 320 (step 555). For these embodiments, the method may continue as illustrated in FIG. 7.

Although FIG. 5 illustrates one example of a method 500 for establishing the communication session, various changes may be made to FIG. 5. For example, while shown as a series of steps, various steps in FIG. 5 could overlap, occur in parallel, occur in a different order, or occur multiple times. Furthermore, as described above, the method 500 may include communicating an identifier for the participant in the communication session that did not initiate the communication session, in addition to an identifier for the initiator. For this embodiment, the social networking service provider 315 may identify approved additional users based on rules provided by both original participants in the communication session. Also, for some embodiments, the communication service provider 310a may perform this method 500 for either of the participants. For example, after receiving the initiation request, the communication service provider 310a may determine whether either the initiating UE 325 or the non-initiating UE 325 has the notification service available and provide the service based on the method 500 for either or both of the UEs 325 based on the determination.

In addition, although the described embodiment includes a single social networking service provider 315, multiple social networking service providers 315 may be included. For these embodiments, the communication service provider 310a and/or the bridge 320 may also identify a particular social networking service provider 315 based on an identifier of a participating UE 325 and provide the appropriate information to the identified social networking service provider 315. Also for these embodiments, the communication service provider 310a may be configured to provide different embodiments of the method 500 (based on the decision steps) for each social networking service provider 315, if desired.

Finally, a similar method may be performed based on any suitable trigger other than the initiation of the communication session. For example, a user may be given the option of initiating the notification portion of the method 500 at any time after the establishment of the communication session instead of the method being performed automatically when the communication session is initiated. In addition, the notification portion of the method 500 may be initiated after a specified period of time has elapsed following the establishment of the communication session. This would give the user time to decide whether he or she wanted to override the default settings provided by the mode rules regarding public/private mode before the method is initiated. If the user selects a private-mode communication session, the communication service provider 310a does not need to continue with the method. Also, a similar method may be performed when the communication session is terminated. At that point, the notification portion of the method 500 may be performed to notify approved users that the communication session is no longer active and, thus, can no longer be joined.

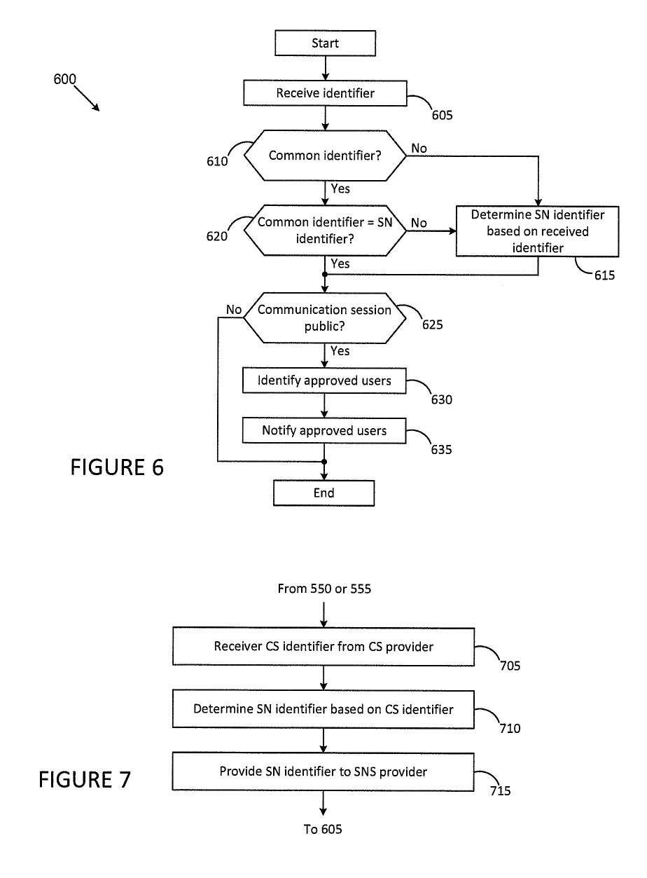

FIG. 6 is a flowchart illustrating a method 600 for notifying additional parties of a communication session that has been established and may be joined in accordance with the present disclosure. The method 600 shown in FIG. 6 is for illustration only. Additional parties may be notified of the established communication session in any other suitable manner without departing from the scope of this disclosure.

Initially, the social networking service provider 315 receives an identifier from the communication service provider 310a (or the bridge 320) (step 605). For example, the social networking service provider 315 may receive a communication service identifier, a social network identifier or a notification identifier.

Although the following description includes decision steps (610 and 620), it will be understood that these steps simply illustrate multiple embodiments. Thus, the social networking service provider 315 may be configured to operate according to a particular one of these embodiments in accordance with the decision step results. In addition, for some embodiments in which the social networking service provider 315 is configured to communicate with multiple communication service providers 310, a single social networking service provider 315 may be configured to operate using more than one of the embodiments provided through the different decision steps.

Thus, for embodiments in which the received identifier is not a common identifier, i.e., an identifier that is known to both the communication service provider 310a and the social networking service provider 315 (step 610), the identifier is a communication service identifier and the social networking service provider 315 determines the social network (SN) identifier based on the received communication service identifier (step 615).

For embodiments in which the received identifier is a common identifier (step 610) and the common identifier is not the social network identifier (step 620), the identifier is a notification identifier and the social networking service provider 315 determines the social network identifier based on the received notification identifier (step 615).

Once the social networking service provider 315 has the social network identifier either by determining the identifier (step 615) or receiving the identifier (for embodiments in which the received identifier is the social network identifier) (step 620), the social networking service provider 315 determines whether or not the communication session is public (step 625). For example, as described in more detail above, the social networking service provider 315 may access stored mode rules that have been configured by the user corresponding to the social network identifier, such as User A, to determine whether the communication session is public or private. Also, as described above, the social networking service provider 315 may determine whether the communication session is public based on a received public/private indicator.

If the social networking service provider 315 determines that the communication session is not public (step 625), the method comes to an end. However, if the social networking service provider 315 determines that the communication session is public (step 625), the social networking service provider 315 identifies one or more additional users that are approved to join the communication session (step 630). For example, as described in more detail above, the social networking service provider 315 may access stored approval rules that have been configured by the user corresponding to the social network identifier, such as User A, to identify which additional users are approved.

After identifying the approved users (step 630), the social networking service provider 315 notifies those approved users (step 635) of the existence of the communication session. For example, as described in more detail above, the social networking service provider 315 may access stored notification rules that have been configured by the approved users to determine a manner in which to notify approved users or, for some approved users, whether or not notification is desired.

For some embodiments, the notification may include a phone number, a website and/or other suitable information that the approved users may use to join the communication session. Also, for some embodiments, the notification may include a join identifier, such a password or code number, that may be used to establish that the user attempting to join the communication session is approved. For example, if a user wants to join an online video chat, the notification may include a website for the user to access, along with a password for identifying the user as approved to join a particular communication session and/or for identifying the particular communication session. It will be understood that the notification may include any suitable information needed by the approved user to join the communication session.

In this way, a user is enabled to discover that his or her friends or associates are engaged in a communication session and is provided a way to join the communication session.

Although FIG. 6 illustrates one example of a method 600 for notifying approved users of the established communication session, various changes may be made to FIG. 6. For example, while shown as a series of steps, various steps in FIG. 6 could overlap, occur in parallel, occur in a different order, or occur multiple times. Furthermore, as described above, the method 600 may include receiving an identifier for both original participants in the communication session. For this embodiment, the social networking service provider 315 may determine a mode for the communication session and/or identify approved additional users based on rules provided by both original participants in the communication session.

Also, although the step related to receiving an identifier at the social networking service provider 315 (step 605) and the step related to determining the social network identifier (step 615) are described as being performed by the social networking service provider 315, it will be understood that this functionality may be provided by the bridge 320, which may be implemented as a part of the social networking service provider 315, as a separate entity, or as a part of the communication service provider 310a, as described above.

Finally, a similar method may be performed based on any suitable trigger other than the initiation of the communication session. For example, a similar method may be performed when the communication session is terminated. At that point, the method 600 may be performed to notify approved users that the communication session is no longer active and, thus, can no longer be joined.

FIG. 7 is a flowchart illustrating a method 700 for operating the bridge 320 as an independent component in accordance with the present disclosure. Thus, the method 700 may be performed when the bridge 320 is implemented independently of the communication service provider 310a and the social networking service provider 315. The method 700 shown in FIG. 7 is for illustration only. The bridge 320 may be operated in any other suitable manner without departing from the scope of this disclosure.

Initially, the bridge 320 receives a communication service (CS) identifier from the communication service provider 310a (step 705). The bridge 320 then determines a social network (SN) identifier based on the communication service identifier (step 710). For example, the bridge 320 may determine the social network identifier by accessing the identifier translator 420 and identifying the social network identifier corresponding to the received communication service identifier. The bridge 320 then provides the social network identifier to the social networking service provider 315 (step 715).

As illustrated in FIG. 7, the bridge 320 may receive the communication service identifier from the communication service provider 310a as a result of step 550 of the method 500 of FIG. 5. Also, the bridge 320 may provide the social network identifier to the social networking service provider 315 as shown in step 605 of the method 600 of FIG. 6. In addition, it will be understood that, for some embodiments, the bridge 320 may also receive a public/private indicator from the communication service provider 310a in step 705 as a result of step 555 of FIG. 5 and provide the received public/private indicator along with the determined social network identifier to the social networking service provider 315 in step 715.

Although FIG. 7 illustrates one example of a method 700 for operating the bridge 320 as an independent component, various changes may be made to FIG. 7. For example, while shown as a series of steps, various steps in FIG. 7 could overlap, occur in parallel, occur in a different order, or occur multiple times.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses may be performed by more, fewer, or other components. The methods may include more, fewer, or other steps. Additionally, as described above, steps may be performed in any suitable order.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for enabling a user to discover and join an established communication session, comprising:
receiving at a social networking service provider an identifier for a first user based on a request to establish a communication session between the first user and a second user;
identifying a third user that is approved to join the communication session; and
notifying the third user of the communication session.

2. The method of claim 1, further comprising determining a mode of the communication session, wherein the mode comprises one of a public mode and a private mode, and wherein identifying a third user comprises identifying the third user when the mode of the communication session is determined to be a public mode.

3. The method of claim 2, further comprising storing one or more mode rules for the first user, and wherein determining the mode of the communication session comprises accessing the mode rules for the first user and determining the mode of the communication session based on the mode rules.

4. The method of claim 2, further comprising storing one Or more approval rules for the first user, and wherein identifying a third user comprises accessing the approval rules for the first user and identifying the third user based on the approval rules.

5. The method of claim 2, further comprising:
receiving at the social networking service provider an identifier for the second user;
storing one or more mode rules for the first user and one or more mode rules for the second user;
storing one or more approval rules for the first user and one or more approval rules for the second user;
wherein determining the mode of the communication session comprises accessing the mode rules for the first user and the mode rules for the second user and determining the mode of the communication session based on the accessed mode rules; and
wherein identifying a third user comprises accessing the approval rules for the first user and the approval rules for the second user and identifying the third user comprises based on the accessed approval rules.

6. The method of claim 1, wherein the identifier comprises a social network identifier, the method further comprising identifying the first user at the social networking service provider based on the social network identifier.

7. The method of claim 1, further comprising:
determining at the social networking service provider a social network identifier based on the identifier; and
identifying at the social networking service provider the first user based on the social network identifier.

8. The method of claim 7, wherein the identifier comprises one of a communication service identifier and a notification identifier.

9. A system for enabling a user to discover and join an established communication session, comprising:
a social networking service provider configured to receive an identifier for a first user, wherein the first user is in an established communication session with a second user, to identify a third user that is approved to join the communication session, and to notify the third user of the communication session.

10. The system of claim 9, wherein the social networking service provider is further configured to determine a mode of the communication session, wherein the mode comprises one of a public mode and a private mode, and wherein the social networking service provider is configured to identify a third user by identifying the third user when the mode of the communication session is determined to be a public mode.

11. The system of claim 10, wherein the social networking service provider is further configured to store one or more mode rules for the first user and one or more approval rules for the first user and to determine the mode of the communication session by accessing the mode rules and determining the mode of the communication session based on the mode rules.

12. The system of claim 9, wherein the identifier comprises one of a social network identifier, a communication service identifier and a notification identifier.

13. A method for enabling a user to discover and join an established communication session, comprising:
providing an identifier corresponding to a first user equipment (UE) associated with a first user to a social networking service provider based on a request to establish a communication session between the first UE and a second UE associated with a second user, wherein the social networking service provider is configured to identify a third user that is approved to join the communication session and to notify the third user of the communication session.

14. The method of claim 13, wherein the identifier comprises a social network identifier, and wherein the social networking service provider is further configured to identify the first user based on the social network identifier.

15. The method of claim 14, wherein the communication service provider is configured to identify the first UE based on a communication service identifier, the method further comprising determining the social network identifier at the communication service provider based on the communication service identifier.

16. The method of claim 14, wherein the communication service provider is configured to identify the first UE based on a communication service identifier, and wherein providing the identifier corresponding to the first UE to the social networking service provider comprises:
providing the communication service identifier to a bridge;
determining at the bridge the social network identifier based on the communication service identifier; and
providing the social network identifier from the bridge to the social networking service provider.

17. The method of claim 13, wherein the identifier comprises a communication service identifier and the communication service provider is configured to identify the first UE based on the communication service identifier.

18. The method of claim 17, wherein the social networking service provider is further configured to determine a social network identifier based on the communication service identifier and identify the first user based on the social network identifier.

19. The method of claim 17, wherein providing the identifier corresponding to the first UE to the social networking service provider comprises:
determining at a bridge a social network identifier based on the communication service identifier; and
providing the social network identifier from the bridge to the social networking service provider, wherein the social networking service provider is further configured to identify the first user based on the social network identifier.

20. The method of claim 13, wherein the identifier comprises a notification identifier, and wherein the social networking service provider is further configured to determine a social network identifier based on the notification identifier and identify the first user based on the social network identifier.
